(19) United States
(12) Patent Application Publication
(10) Pub. No.: US 2014/0078161 A1
(43) Pub. Date: Mar. 20, 2014

(54) IMAGE PROCESSING DEVICE FOR SCROLLING DISPLAY OF AN IMAGE

(71) Applicant: CASIO COMPUTER CO., LTD., Tokyo (JP)

(72) Inventor: Hiroshi SUZUKI, Tokyo (JP)

(21) Appl. No.: 13/943,502

(22) Filed: Jul. 16, 2013

(30) Foreign Application Priority Data
Sep. 14, 2012 (JP) 2012-203254

(51) Int. Cl. G06T 1/60

(52) U.S. Cl. CPC G06T 1/60
USPC 345/531

(57) ABSTRACT

An image processing device reads data of plural pixels constituting an image in plural rows and plural columns from a display memory and displays the image at a display device. All of the pixel data constituting the image is continuously read in a sequence of addresses, continuing from an address that stores pixel data that is read last in one row to an address that stores pixel data that is read first in the next row. When the position of the image being displayed on the display device is to be changed, the address at which the continuous reading starts is altered.

This application is based on and claims the benefit of priority from Japanese Patent Application No. 2012-203254, filed on 14 Sep. 2012, the content of which is incorporated herein by reference.

### BACKGROUND OF THE INVENTION

1. Field of the Invention

The present invention relates to an image processing device that implements a scrolling display of an image, and to an image processing method and a storage medium storing a program.

2. Related Art

Since heretofore, to realize a lightweight, portable digital camera, reductions in cost and size are required. As a response to these requirements, application software is employed with the expectation that an underpowered central processing unit (CPU), a small-capacity memory and the like are to be used.

Even when such application software is employed, it is required that a user interface be as rich in appearance as possible. One response to this requirement is the inclusion of image scrolling processing (Reference Document 1: Japanese Unexamined Patent Publication No. 2000-125251).

### SUMMARY OF THE INVENTION

One aspect of the present invention is

an image processing device including:

a display memory that stores data of an image to be displayed at a display device, which is data of a plurality of pixels constituting the image in a plurality of rows and a plurality of columns;

a reading section that implements reading processing that reads the image data stored in the display memory and causes the image data to be displayed at the display device, the reading processing reading a plurality of the pixel data stored in the display memory in a storage address sequence, causing the sequentially read pixel data to be sequentially displayed while advancing a column position at the display device, and advancing a row position of the display at the display device each time reading of the pixel data corresponding to one row is complete; and

a reading position setting section that changes a position of the image displayed at the display device by altering positions of the reading of the plurality of pixel data by the reading section,

wherein

the reading section continuously reads all of the pixel data constituting the image in the address sequence, continuing from an address that stores the pixel data that is read last in a row to an address that stores the pixel data that is read first in the next row, and

the reading position setting section changes the position of the whole image displayed at the display device by altering an address at which the continuous reading of all the pixel data constituting the image starts.

Another aspect of the present invention is

an image processing method

executed by an image processing device equipped with a display memory that stores data of an image to be displayed at a display device, which is data of a plurality of pixels constituting the image in a plurality of rows and a plurality of columns, the image processing method comprising:

a reading step of implementing reading processing that reads the image data stored in the display memory and causes the image data to be displayed at the display device, the reading processing reading a plurality of the pixel data stored in the display memory in a storage address sequence, causing the sequentially read pixel data to be sequentially displayed while advancing a column position at the display device, and advancing a row position of the display at the display device each time reading of the pixel data corresponding to one row is complete; and

a reading position setting step of changing a position of the image displayed at the display device by altering positions of the reading of the plurality of pixel data by the reading step,

wherein

the reading step includes continuously reading all of the pixel data constituting the image in the address sequence, continuing from an address that stores the pixel data that is read last in a row to an address that stores the pixel data that is read first in the next row, and

the reading position setting step includes changing the position of the whole image displayed at the display device by altering an address at which the continuous reading of all the pixel data constituting the image starts.

Another aspect of the present invention is

a non-transitory storage medium

having stored therein a program executable by a computer that controls an image processing device equipped with a display memory that stores data of an image to be displayed at a display device, which is data of a plurality of pixels constituting the image in a plurality of rows and a plurality of columns, causing the computer to realize:

a reading function that implements reading processing that reads the image data stored in the display memory and causes the image data to be displayed at the display device, the reading processing reading a plurality of the pixel data stored in the display memory in a storage address sequence, causing the sequentially read pixel data to be sequentially displayed while advancing a column position at the display device, and advancing a row position of the display at the display device each time reading of the pixel data corresponding to one row is complete; and

a reading position setting function that changes a position of the image displayed at the display device by altering positions of the reading of the plurality of pixel data by the reading function,

wherein

the reading function continuously reads all of the pixel data constituting the image in the address sequence, continuing from an address that stores the pixel data that is read last in a row to an address that stores the pixel data that is read first in the next row, and

the reading position setting function changes the position of the whole image displayed at the display device by altering an address at which the continuous reading of all the pixel data constituting the image starts.

### BRIEF DESCRIPTION OF THE DRAWINGS

FIG. 1 is a block diagram showing hardware structures of an image processing device in accordance with an embodiment of the present invention.

FIG. 2 is a functional block diagram illustrating, of functional structures of the image processing device of FIG. 1, functional structures for executing scrolling processing.

FIG. 3 is a diagram showing examples of an original image and an altered image.

FIG. 4 is a diagram showing an initial state at a point in time at which the execution of scrolling processing is started.

FIG. 5 is a diagram showing a state, after a scrolling instruction in the left-right direction from the initial state in FIG. 4 has been given, in which scrolling by one column has been implemented.

FIG. 6 is a diagram showing a state in which scrolling by one column has been implemented from the state that has been scrolled by one column in FIG. 5.

FIG. 7 is a diagram showing a state in which scrolling by one column has been implemented from the state that has been scrolled by two columns in FIG. 6.

FIG. 8 is a diagram showing a state in which scrolling by seven columns has been implemented from the initial state in FIG. 4.

FIG. 9 is a diagram showing a state in which scrolling by eight columns has been implemented from the initial state in FIG. 4.

FIG. 10 shows a state after scrolling processing has ended.

FIG. 11 is a flowchart describing the scrolling processing that is executed by the image processing device of FIG. 1 with the functional structures of FIG. 2.

### DETAILED DESCRIPTION OF THE INVENTION

In the following, embodiments of the present invention are explained using the attached drawings.

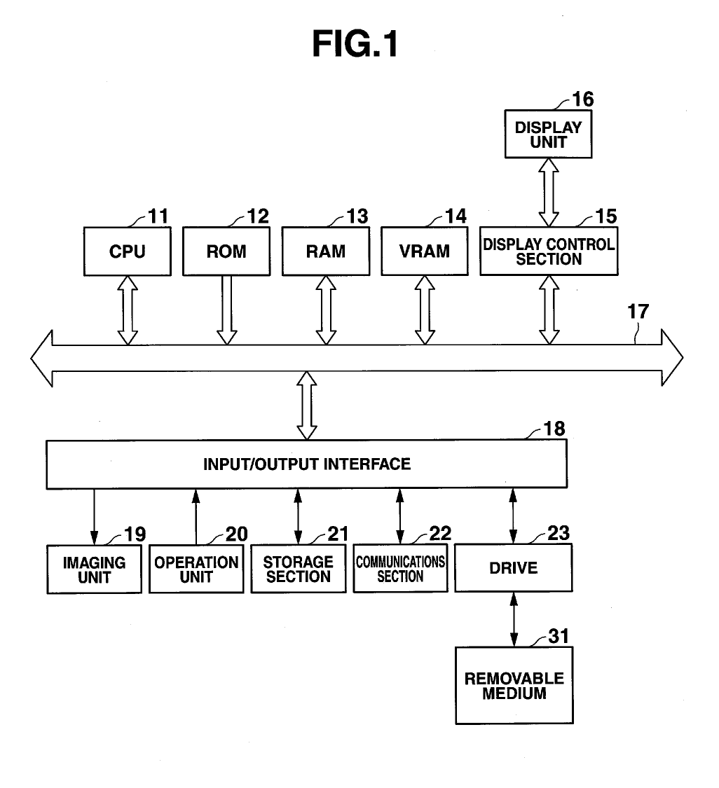

FIG. 1 is a block diagram showing hardware structures of an image processing device in accordance with an embodiment of the present invention.

The image processing device is configured as, as an example, a digital camera.

The image processing device is equipped with a CPU 11, a read-only memory (ROM) 12, a random access memory (RAM) 13, a video random access memory (VRAM) 14, a display control section 15, a display unit 16, a bus 17, an input/output interface 18, an imaging unit 19, an operation unit 20, a storage section 21, a communications section 22 and a drive 23.

The CPU 11 executes various processes in accordance with a program stored in the ROM 12 or a program loaded into the RAM 13 from the storage section 21.

Data and suchlike that is required for execution of the various processes by the CPU 11 is stored in the RAM 13 as appropriate.

The VRAM 14 functions as a display memory, and stores data of images that are targets of display by the display unit 16 as appropriate.

The display control section 15 executes control to read image data from the VRAM 14 and cause an image to be displayed at the display unit 16. The display unit 16 is structured with a display and the like, and displays various kinds of images in accordance with control by the display control section 15.

The CPU 11, the ROM 12, the RAM 13, the VRAM 14 and the display control section 15 are connected to one another via the bus 17. The bus 17 is also connected with the input/output interface 18. The input/output interface 18 is connected to the imaging unit 19, the operation unit 20, the storage section 21, the communications section 22 and the drive 23.

The imaging unit 19 is provided with an optical lens unit and an image sensor, which are not shown in the drawings.

The optical lens unit is structured with lenses that focus light for imaging objects, e.g., a focusing lens and a zoom lens or the like.

The focusing lens is a lens for forming an image of an object on a light detection surface of the image sensor. The zoom lens is a lens for freely varying the focusing distance within a predetermined range.

The optical lens unit also includes peripheral circuits for adjusting setting parameters, such as focus, exposure, white balance and the like, as necessary.

The image sensor is structured with an photoelectric conversion component, an AFE (Analog Front End), and the like.

The photoelectric conversion component is structured by, for example, a CMOS-based (complementary metal oxide semiconductor) photoelectric conversion component or the like. An image of an object is incident on the photoelectric conversion component through the optical lens unit. The photoelectric conversion component photoelectrically converts (captures) the image of the subject, accumulates the resultant image signals for a predetermined duration, and sequentially supplies the accumulated image signals to the AFE as analog signals.

The AFE applies various kinds of signal processing such as analog-to-digital (A/D) conversion processing and the like to the analog image signals. The various kinds of signal processing generate a digital signal, which is output as an output signal from the imaging unit 19.

The output signals from the imaging unit 19 are referred to hereinafter as “image data”. The data of captured images is provided to the CPU 11 and the like as appropriate.

The operation unit 20 is structured with various buttons and the like and inputs various kinds of information in accordance with instruction operations by a user.

The storage section 21 is structured with a dynamic random access memory (DRAM) or the like, and stores various kinds of data.

The communications section 22 controls communications with other devices (not illustrated) via networks, including the Internet.

A removable medium 31 formed with a magnetic disk, an optical disk, a magneto-optical disk, a semiconductor memory, or the like is installed in the drive 23, as appropriate. The removable medium 31 may store various kinds of data such as image data and the like.

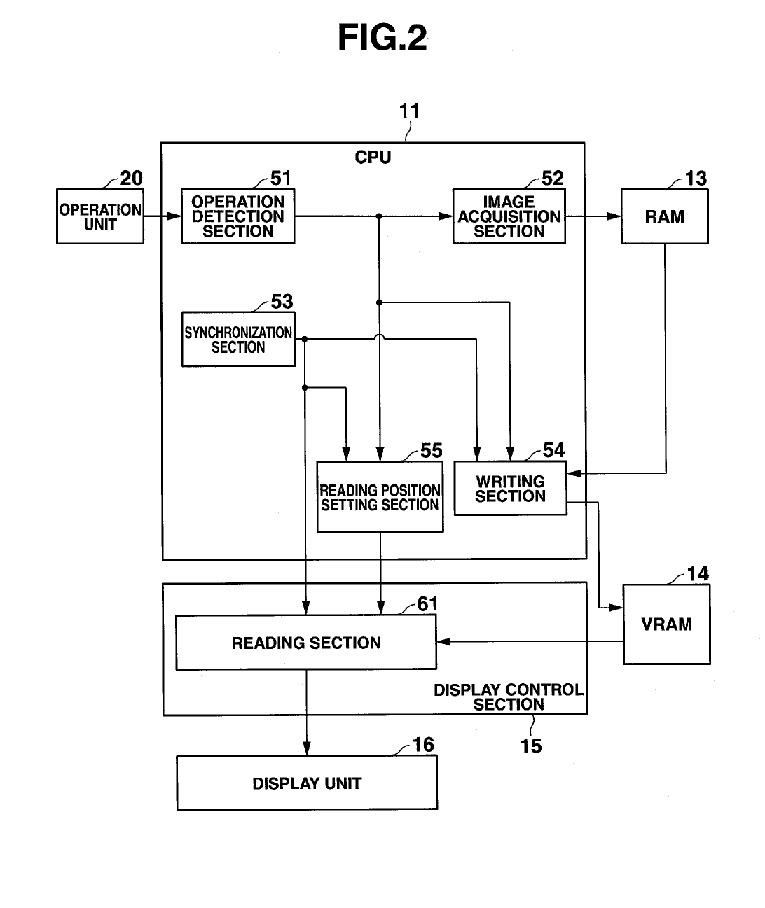

FIG. 2 is a functional block diagram illustrating, of functional structures of the image processing device of FIG. 1, functional structures for implementing scroll processing.

The term “scrolling processing” used herein is intended to include a sequence of processing that is executed in order to implement displays such that an image can be slid in certain directions, such as a left-right direction (a column arrangement direction) and an up-down direction (a row arrangement direction) or the like when a display target of the display unit 16 is changing from a first image (referred to hereinafter as an “original image”) to a second image (referred to hereinafter as an “altered image”).

Techniques that are ordinarily employed for scrolling processing include the following two techniques.

The first technique is a technique of reserving a display memory that is two or more times as large as a display size and, in a state in which data of the first image and the second image is stored in the display memory, progressively shifting a range of reading from the display memory (referred to hereinafter as a “scan range”) of image data for display.

The second technique is a technique in which a scanning range in the display memory is fixed and the image data for display that is in the scanning range is overwritten little by little.

However, if the first technique were to be employed in the present embodiment, the VRAM 14 would have to be at least twice the display size to serve as the display memory, and a corresponding proportion of the VRAM 14 would be unused when scrolling processing was not being executed.

Alternatively, if the second technique were to be used in the present embodiment, equipment with a CPU 11 with a sufficiently high performance would be required.

However, with a view to reducing size and reducing costs, an image processing device 1 of the present embodiment, which is a digital camera, requires a low-performance (underpowered) CPU 11 and a low-capacity VRAM 14.

Therefore, it would be difficult to employ the first and second techniques described above in the present embodiment.

Accordingly, in the present embodiment, a technique is employed in which, each time a display is updated, image data for the display is overwritten in the VRAM 14 one column (one line in the vertical direction) at a time and an initial reading position from the VRAM 14 (referred to hereinafter as “the scanning start position”) is altered.

As a result, the capacity (memory size) of the VRAM 14 need be only a little larger than the display size, and the scrolling processing may be executed by the low-performance CPU 11.

When the scrolling processing is being executed, the CPU 11 functions as an operation detection section 51, an image acquisition section 52, a synchronization section 53, a writing section 54 and a reading position setting section 55, as shown in FIG. 2. The display control section 15 functions as a reading section 61.

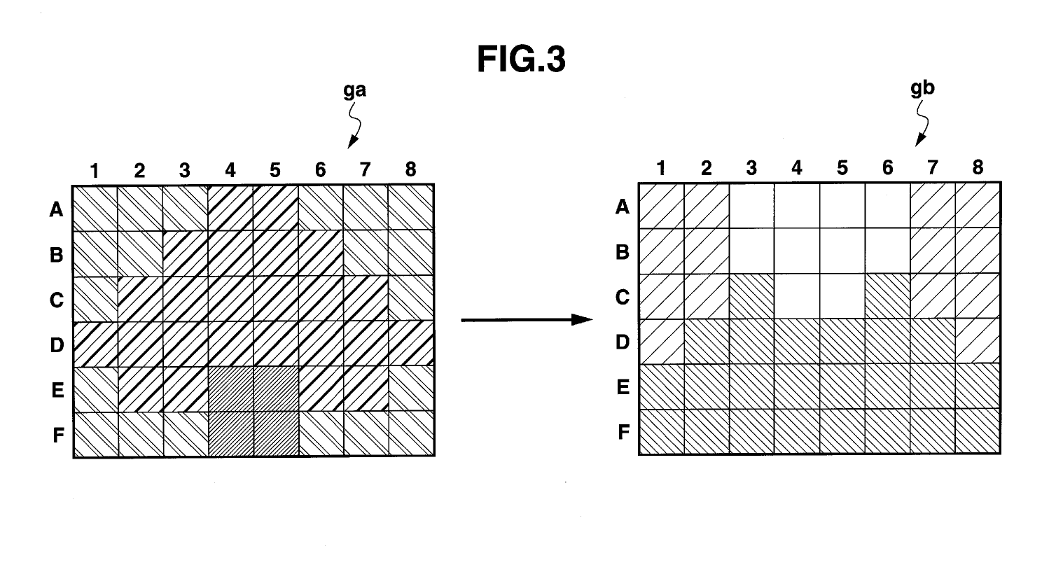

Herebelow, the respective functions of the operation detection section 51, image acquisition section 52, synchronization section 53, writing section 54 and reading position setting section 55 and the reading section 61 are described with reference to FIG. 3 to FIG. 10.

FIG. 3 shows examples of the original image and the altered image.

In the following example, the display target of the display unit 16 is scrolled in the left-right direction while being altered from the original image ga at the left side of FIG. 3 to the altered image gb at the right side of FIG. 3.

For ease of description in the following example, the resolution (display size) of the display unit 16 is a size of 8 by 6 pixels, and the original image ga and the altered image gb are the same size.

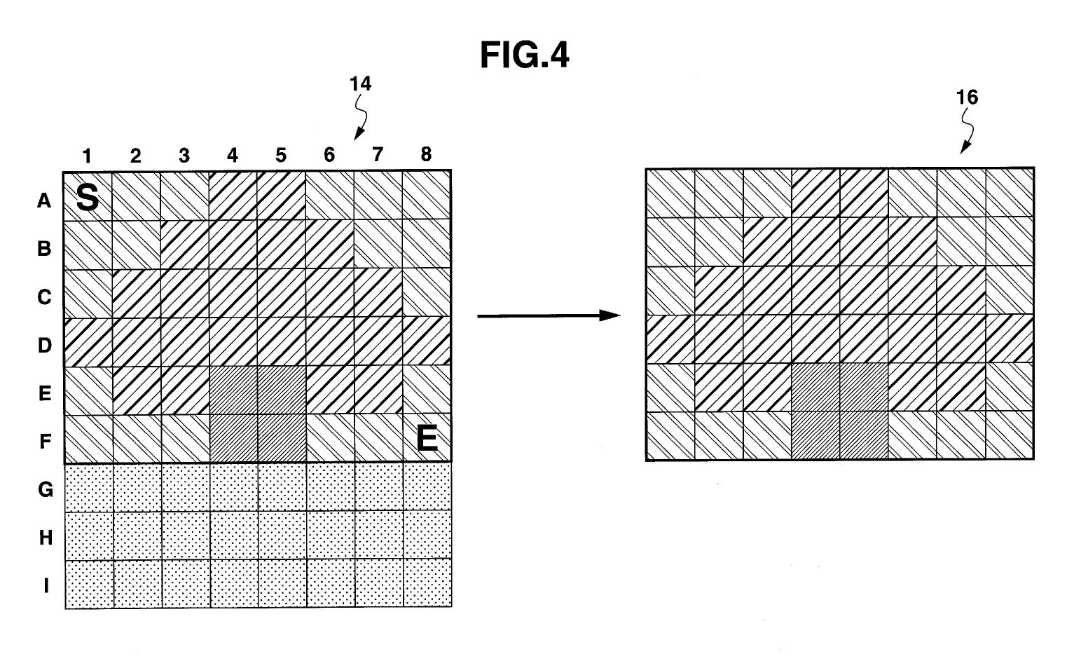

FIG. 4 shows a state at the point in time when execution of the scrolling processing is started (hereinafter referred to as “the initial state”).

In the initial state, data of the original image ga is deployed in the VRAM 14.

As shown in FIG. 4, the VRAM 14 has a capacity exceeding the image size of the original image ga. In the initial state, of pixels structuring the display target image, data (a pixel value) of a pixel at row m, column n (m is an arbitrary value from A to I and n is an arbitrary value from 1 to 8) is stored at the address of row m, column n in the VRAM 14.

The reading section 61 of the display control section 15 reads the data of 8 by 6 pixels from a predetermined region of the VRAM 14, from row A, column 1 to row F, column 8 in “raster scanning” order in the present embodiment, and causes the display unit 16 to display an image constituted by the 8 by 6 pixels.

The term “raster scanning” used herein is intended to include a process of scanning that scans first in one or other direction in a two-dimensional plane represented by, for example, a row direction and a column direction, a horizontal direction and a vertical direction, an X direction and a Y direction, or the like, and the term “raster scanning order” is intended to include a sequence of this scanning.

For convenience herebelow, a case of scanning first in the column arrangement direction (scanning with the column being advanced first and the row being advanced when the final column has been reached) is described. That is, the column arrangement direction described herebelow represents the direction that is scanned first, and is not limited to a physical direction that is a horizontal direction or a vertical direction or the like.

In FIG. 4, the data of the original image ga is stored in a predetermined region of the VRAM 14, and the original image ga is displayed at the display unit 16.

Of the addresses in the VRAM 14, the address indicated with “S”, row A, column 1 in the example in FIG. 4, is the start position of reading by the reading section 61 (the scanning start position), and of the addresses in the VRAM 14, the address indicated with “E”, row F, column 8 in the example in FIG. 4, is the end position of reading by the reading section 61 (referred to hereinafter as “the scanning end position”). That is, the reading section 61 starts the reading of pixel data from the reading start position indicated with “S”, sequentially reads the image data in the raster scanning order, and finishes the reading of the pixel data at the reading end position indicated with “E”.

In the present embodiment, correspondence information relating addresses in the VRAM 14 with positions on a display screen of the display unit 16 (pixel positions) are saved beforehand in the RAM 13 or the like. This correspondence information relates the address in the VRAM 14 indicated with “S”, which is the reading start position (scanning start position), with the position of a pixel (an effective pixel) at the top-left corner of the display unit 16, and relates the address in the VRAM 14 indicated with “E”, which is the reading end position (scanning end position), with the position of a pixel (an effective pixel) at the bottom-right corner of the display unit 16.

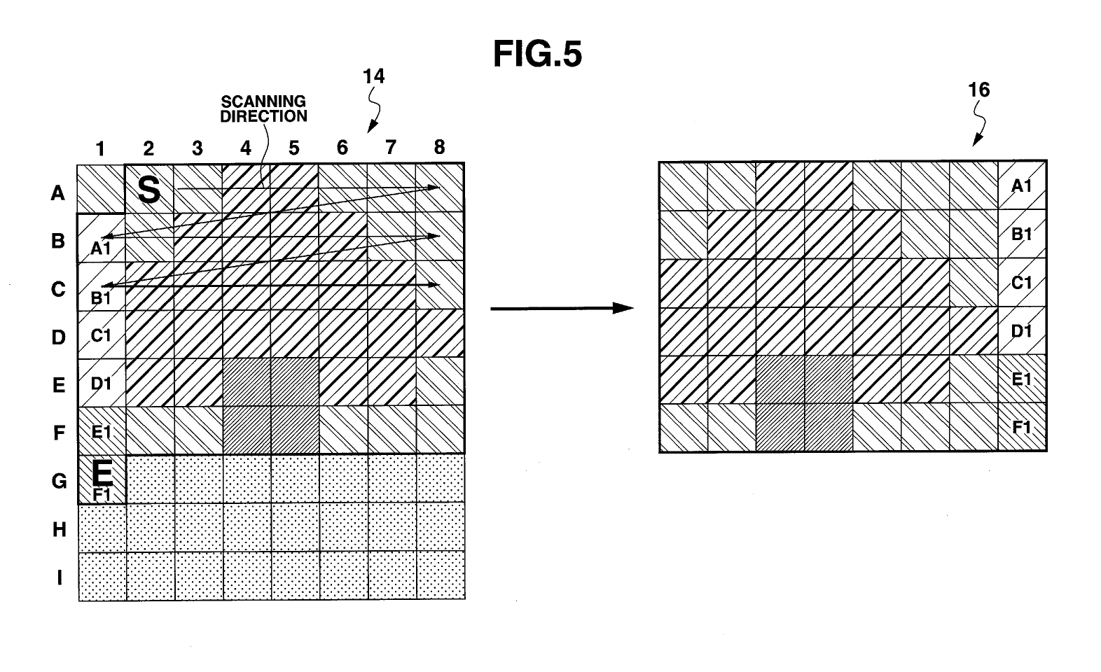

Thus, the reading section 61 of the display control section 15 displays the original image ga at the display unit 16, as illustrated at the right side of FIG. 4, by reading the pixel data from the VRAM 14 in the raster scanning order in accordance with the correspondence information, scanning the display unit 16 in the raster scanning order (see the left side of FIG. 5), and displaying the pixels at the corresponding positions of the display screen.

The synchronization section 53 synchronizes operations of the writing section 54, the reading position setting section 55 and the reading section 61 in accordance with vertical synchronization signals and horizontal synchronization signals.

In the initial state in FIG. 4, a user operates the operation unit 20 and instructs, for example, scrolling in the leftward direction.

At this time, the operation detection section 51 detects the operation and sends an instruction to scroll to the left to the image acquisition section 52, the writing section 54 and the reading position setting section 55. Herein, for convenience of description, a case in which the operation detection section 51 detects a scrolling instruction from a manual operation by a user is described. However, directions and amounts of scrolling that are automatically determined by methods other than manual operations by users may be received as scrolling instructions.

When the image acquisition section 52 receives the leftward scrolling instruction, the image acquisition section 52 acquires the data of the altered image gb and stores the altered image gb data in the RAM 13.

FIG. 5 shows a state, after the leftward scrolling instruction from the initial state in FIG. 4 has been given, in which scrolling by one column has been implemented.

The writing section 54 reads the data in the leftmost column of the altered image gb data stored in the RAM 13, and writes this data to the leftmost column in the VRAM 14, offsetting this data one row downward, as shown at the left side of FIG. 5. That is, the pixel data of row A, column 1 in the altered image gb (corresponding to the pixel position of the top-left corner) is written over the original image ga at the position at row B, column 1.

Then, the reading position setting section 55 updates the correspondence information such that the scanning start position is shifted one pixel rightward, to the position of row A, column 2. That is, in the correspondence information, the reading start position in the VRAM 14 indicated with “S” (the scanning start position) that is related to the position of the pixel (effective pixel) at the top-left corner of the display unit 16, is updated from row A, column 1 to row A, column 2. Meanwhile, the reading end position in the VRAM 14 indicated with “E” (the scanning end position) that is related to the position of the pixel (effective pixel) at the bottom-right corner of the display unit 16, is updated from row F, column 8 to row G, column 1.

The reading section 61 of the display control section 15 causes the display unit 16 to display the image shown at the right side of FIG. 5, which is an image scrolled by one column, by reading the pixel data from the VRAM 14 in the raster scanning order in accordance with the updated correspondence information, scanning the display unit 16 in the raster scanning order, and displaying the pixels (see the left side of FIG. 5) at the corresponding positions of the display screen.

At this time, the synchronization section 53 may synchronize the writing section 54, the reading position setting section 55 and the reading section 61 such that the image displayed at the display unit 16 is updated in accordance with the vertical synchronization signals and such that each row of the image displayed at the display unit 16 is displayed in accordance with the horizontal synchronization signals. The reading section 61 reads the pixel data from the VRAM 14 in synchronization with the horizontal synchronization signals, continuing from the address of the pixel that is scanned (displayed) last (at the rightmost end) of a row m to the pixel address that is scanned (displayed) first (at the start end) of the following row m+1.

For example, after a pulse (rise) of the vertical synchronization signals is supplied, when the next pulse (rise) of the horizontal synchronization signals is supplied, the reading section 61 starts reading from the reading start position in the VRAM 14 indicated with “S” (the scanning start position), which is to say, the pixel data at the position of row A, column 2.

Thereafter, the pixel data of row A from column 3 to column 8 is read in this order (from left to right).

Now, conventionally, when the pixel data up to row A, column 8 (the last column of row A) has been read, the processing goes into a standby state until the next pulse (rise) of the horizontal synchronization signals is supplied. By contrast, in the present embodiment, after the pixel data of row A from column 3 to column 8 has been read in this order (from left to right), the reading operations do not stop but are simply continued. That is, the reading target row changes to row B, and the pixel data at the position of row B, column 1 is read out. In this manner, the pixel data to be displayed in the topmost horizontal line of the display unit 16 is read out. Then, until the next pulse (rise) of the horizontal synchronization signals is supplied, the processing goes into the standby state.

When the next pulse (rise) of the horizontal synchronization signals is supplied, the reading section 61 starts reading from the pixel data at the position of row B, column 2 in the VRAM 14.

Thereafter, the pixel data of row B from column 3 to column 8 is read in this order (from left to right). After the pixel data of row B from column 3 to column 8 has been read in this order (from left to right), the reading operations do not stop but are simply continued. That is, the reading target row changes to row C, and the pixel data at the position of row C, column 1 is read out. In this manner, the pixel data to be displayed in the second horizontal line from the top of the display unit 16 is read out. Then, until the next pulse (rise) of the horizontal synchronization signals is supplied, the processing goes into the standby state.

The processing controlling the reading is repeatedly executed in the same manner for all the horizontal lines from the third line from the top of the display unit 16 onward.

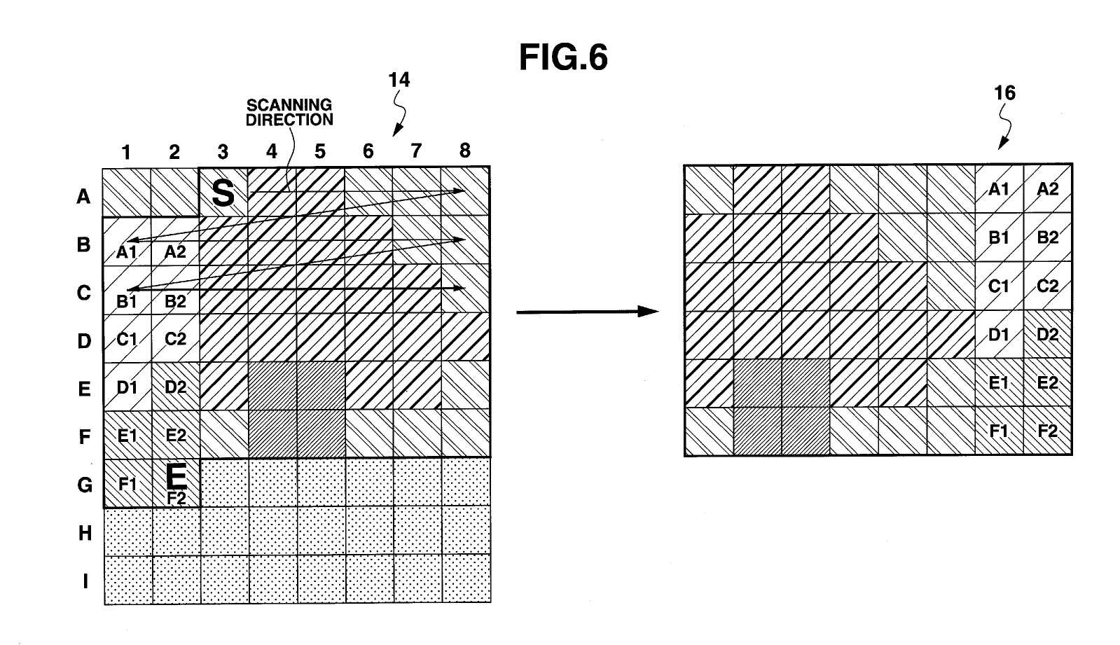

This synchronization control is repeatedly executed through the states shown in FIG. 6 to FIG. 10. However, descriptions are the same so will not be repeated below.

FIG. 6 shows a state in which scrolling by one column has been implemented from the state that has been scrolled by one column in FIG. 5 (by two columns from the initial state).

The writing section 54 reads the data of a second column from the left in the altered image gb data stored in the RAM 13, and writes this data to the second column from the left in the VRAM 14, offsetting this data one row downward, as shown at the left side of FIG. 6. That is, the pixel data of row A, column 2 in the altered image gb is written to the position of row B, column 2 in the original image ga.

Then, the reading position setting section 55 updates the correspondence information such that the scanning start position is shifted one pixel rightward (two pixels from the initial state) to the position of row A, column 3. That is, in the correspondence information, the reading start position in the VRAM 14 indicated with “S” (the scanning start position) that is related to the position of the pixel (effective pixel) at the top-left corner of the display unit 16, is updated from row A, column 2 to row A, column 3. Meanwhile, the reading end position in the VRAM 14 indicated with “E” (the scanning end position) that is related to the position of the pixel (effective pixel) at the bottom-right corner of the display unit 16, is updated from row G, column 1 to row G, column 2.

The reading section 61 of the display control section 15 causes the display unit 16 to display the image shown at the right side of FIG. 6, which is an image scrolled by two columns, by reading the pixel data from the VRAM 14 in the raster scanning order in accordance with the updated correspondence information, scanning the display unit 16 in the raster scanning order, and displaying the pixels (see the left side of FIG. 6) at the corresponding positions of the display screen.

At this time, the reading section 61 reads the pixel data from the VRAM 14 in synchronization with the horizontal synchronization signals, continuing from the address of the pixel that is scanned (displayed) last (at the rightmost end) of a row to the pixel address that is scanned (displayed) first (at the start end) of the following row.

For example, after a pulse (rise) of the vertical synchronization signals is supplied, when the next pulse (rise) of the horizontal synchronization signals is supplied, the reading section 61 starts reading from the reading start position in the VRAM 14 indicated with “S” (the scanning start position), which is to say, the pixel data at the position of row A, column 3.

Thereafter, the pixel data of row A from column 4 to column 8 is read in this order (from left to right).

Conventionally, when the pixel data up to row A, column 8 (the last column of row A) has been read, the processing goes into a standby state until the next pulse (rise) of the horizontal synchronization signals is supplied. By contrast, in the present embodiment, after the pixel data of row A from column 3 to column 8 has been read in this order (from left to right), the reading operations do not stop but are simply continued. That is, the reading target row changes to row B, and the pixel data at the position of row B, column 1 and column 2 is read out. In this manner, the pixel data to be displayed in the topmost horizontal line of the display unit 16 is read out. Then, until the next pulse (rise) of the horizontal synchronization signals is supplied, the processing goes into the standby state.

When the next pulse (rise) of the horizontal synchronization signals is supplied, the reading section 61 starts reading from the pixel data at the position of row B, column 3 in the VRAM 14.

Thereafter, the pixel data of row B from column 4 to column 8 is read in this order (from left to right). After the pixel data of row B from column 4 to column 8 has been read in this order (from left to right), the reading operations do not stop but are simply continued. That is, the reading target row changes to row C, and the pixel data at the position of row C, column 1 and column 2 is read out. In this manner, the pixel data to be displayed in the second horizontal line from the top of the display unit 16 is read out. Then, until the next pulse (rise) of the horizontal synchronization signals is supplied, the processing goes into the standby state.

The processing controlling the reading is repeatedly executed in the same manner for all the horizontal lines from the third line from the top of the display unit 16 onward.

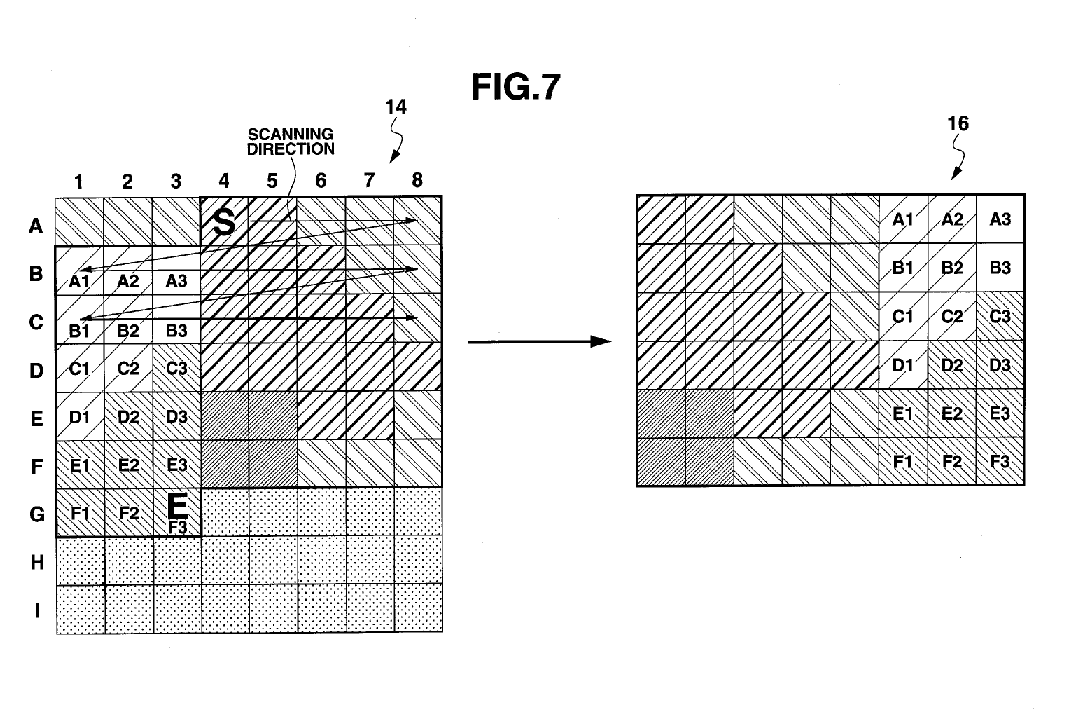

FIG. 7 shows a state in which scrolling by one column has been implemented from the state that has been scrolled by two columns in FIG. 6 (by three columns from the initial state).

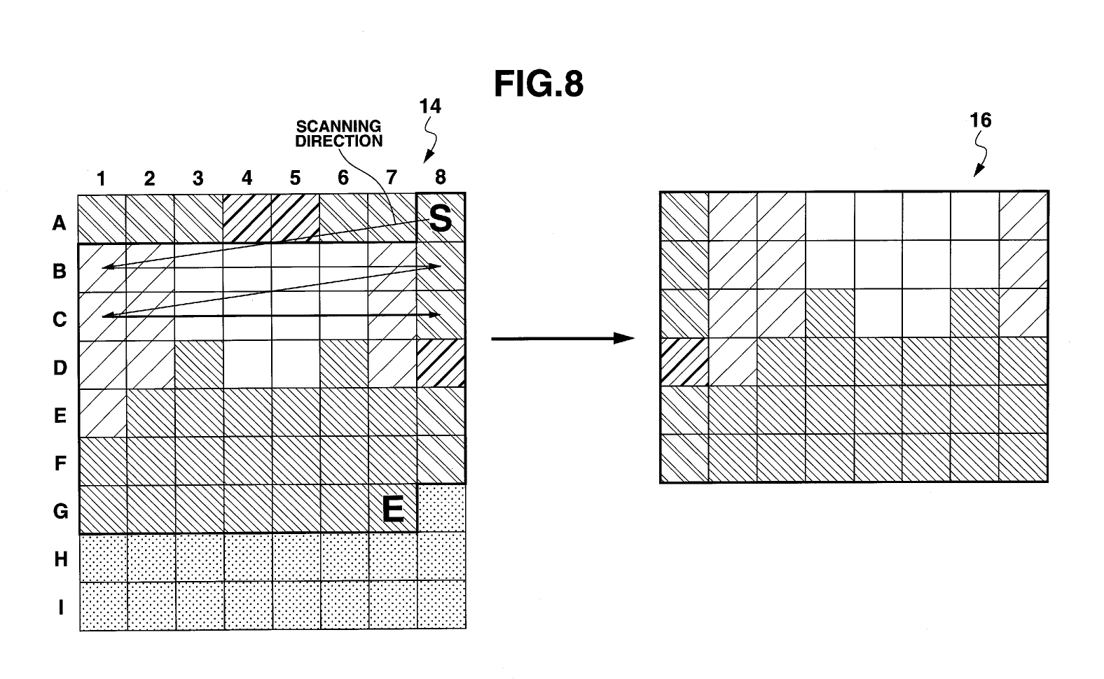

FIG. 8 shows a state in which scrolling by seven columns has been implemented from the initial state.

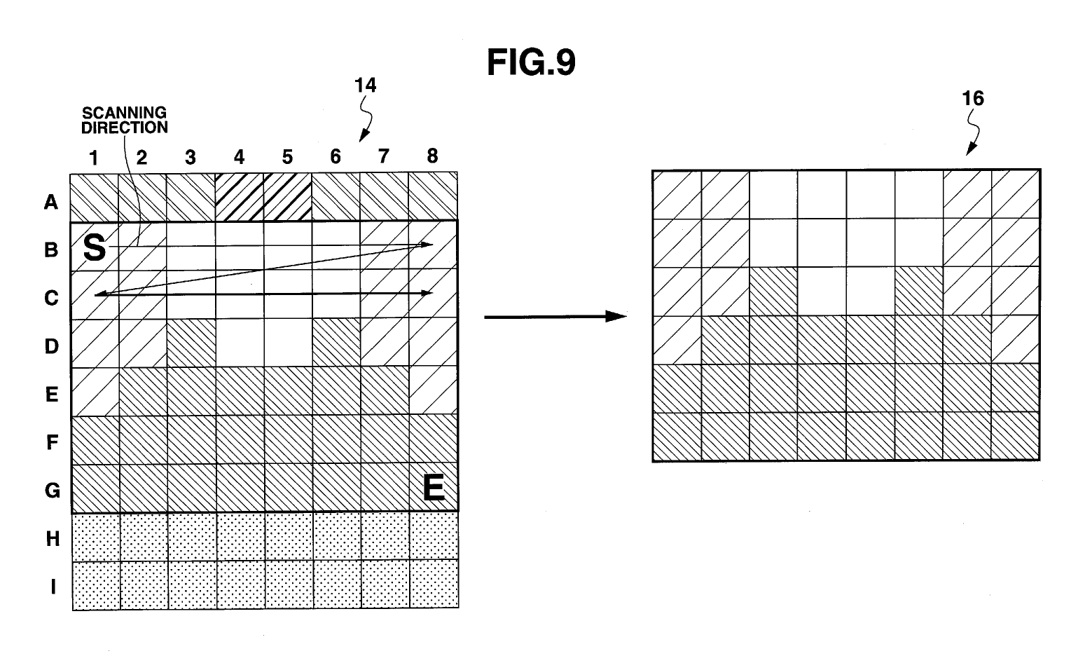

FIG. 9 shows a state in which scrolling by eight columns has been implemented from the initial state.

At each stage, processing basically the same as that described using FIG. 5 and FIG. 6 is executed, which has been described above so is not described here.

As is clear from FIG. 4 to FIG. 9 and the descriptions above, it is sufficient that the VRAM 14 be provided with free space corresponding to at least one row of the image to serve as a storage region of image data that is a display target for the display unit 16.

Here, an image is displayed at the display unit 16 by the display control section 15 sequentially reading the pixel data in the raster scanning order in accordance with the correspondence information that has been altered by the CPU 11, continuing from the address in the VRAM 14 of the pixel that is scanned last in a row n (n being an integer value in the range from 1 to N, and N being the number of rows in the image) to the address of the pixel that is scanned first in row n+1, and the pixels being sequentially displayed at corresponding positions of the display unit 16.

Thus, the capacity of a buffer memory for scrolling (the VRAM 14) may be reduced without lowering a speed of scrolling. Moreover, scrolling may be implemented without the provision of complex address conversion circuitry, simply by altering the address of the reading start position (the scanning start position).

That is, an effect is provided in that satisfactory image scrolling can be implemented even under conditions of an underpowered CPU 11 and a small-capacity VRAM 14.

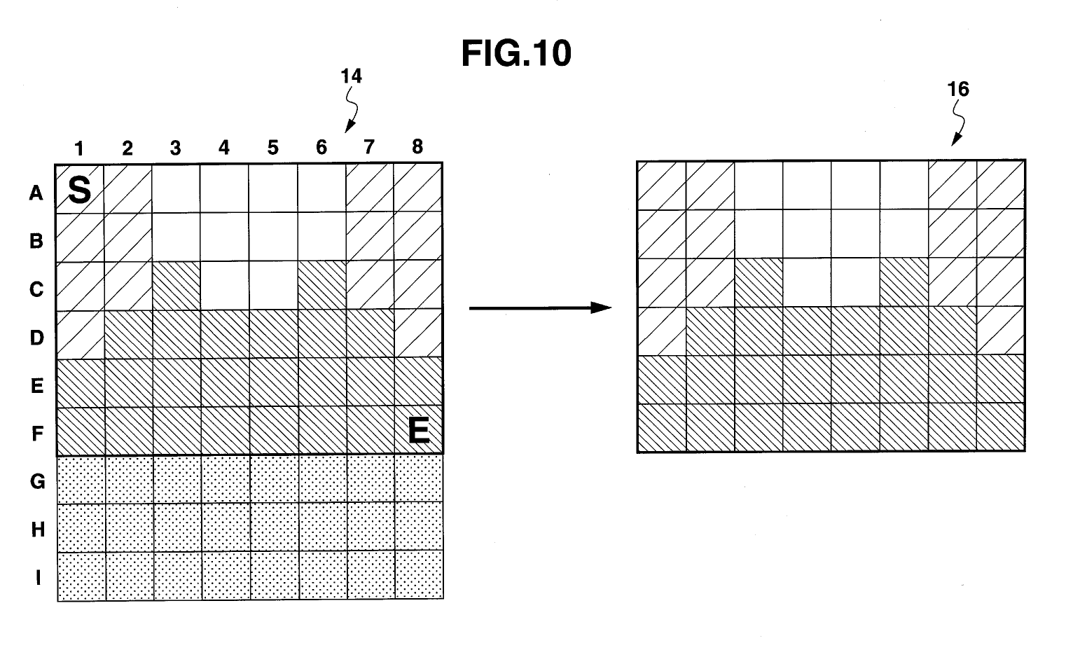

FIG. 10 shows a state when the scrolling processing has ended.

That is, although the scrolling processing is complete in the state shown in FIG. 9, the altered image gb is then re-written directly to the VRAM 14, without the offsetting, for a subsequent scrolling process, for which the current altered image gb will be the original image. Correspondingly, the scanning start position and the scanning end position are returned to the initial state.

That is, the VRAM 14 is provided with free space corresponding to K rows (K being an integer value that is at least 1) to serve as the storage region. If, after scrolling by K×(the number of pixels in one row) columns in the column arrangement direction, the CPU 11 is caused to continue with further scrolling in the same direction or, after scrolling by K rows in the row arrangement direction, is caused to continue with further scrolling in the same direction, the CPU 11 updates all of the data in the VRAM 14.

Thus, rapid scrolling in the column arrangement direction within a range corresponding to K×(the number of pixels in one row) is enabled just by providing a free space corresponding to K rows in the VRAM 14.

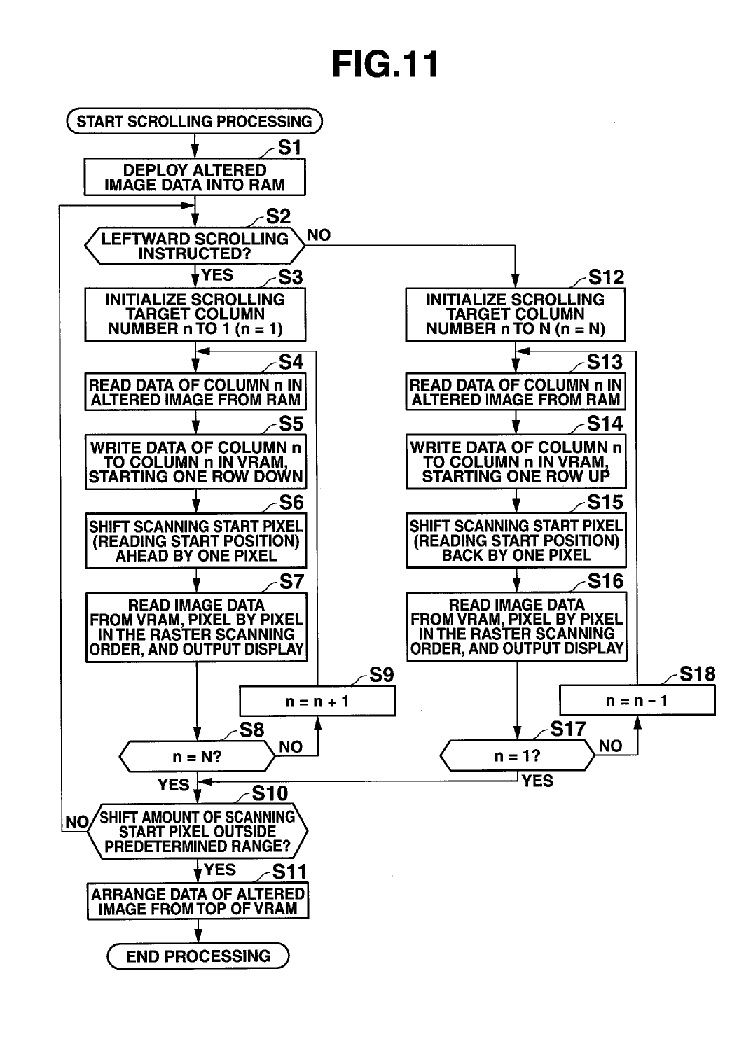

Now, the scrolling processing executed by this image processing device with the functional structures of FIG. 2 is described with reference to FIG. 11.

FIG. 11 is a flowchart describing the flow of the scrolling processing.

In the present embodiment, the scrolling processing is initiated, in a state in which an image (an original image) is displayed at the display unit 16, by a scrolling instruction operation by a user being received from the operation unit 20 by the operation detection section 51.

In step S1, the image acquisition section 52 acquires, for example, imaged image data or the like to be the altered image data and deploys this data into the RAM 13.

In the state before scrolling begins, the reading position setting section 55 initializes the scanning start position (the reading start position) (to the pixel position at row 1, column 1 in the VRAM 14).

In step S2, the operation detection section 51 makes a determination as to whether the received instruction is a leftward scrolling instruction.

If the received instruction is a leftward scrolling instruction, the result of the determination in step S2 is affirmative, and the processing in the loop from step S3 to step S9 is executed. On the other hand, if the received instruction is not a leftward scrolling instruction, that is, if the received instruction is a rightward scrolling instruction, the result of the determination in step S2 is negative, and the processing in the loop from step S12 to step S18 is executed.

The processing of the loop from step S3 to step S9 that is executed in the case of a leftward scrolling instruction (when the result in step S2 is affirmative) is described first herebelow. Thereafter, the processing of the loop from step S12 to step S18 that is executed in the case of a rightward scrolling instruction (when the result in step S2 is negative) is described.

As mentioned above, in the case of a leftward scrolling instruction, the result of the determination in step S2 is affirmative and the processing proceeds to step S3.

In step S3, the writing section 54 initializes a scrolling target column number n to 1 (n=1).

In step S4, the writing section 54 reads the data of column n of the altered image from the RAM 13.

In step S5, the writing section 54 writes this data of column n to column n of the VRAM 14, starting (offset by) one row downward.

In step S6, the reading position setting section 55 updates the correspondence information so as to shift the scanning start position (the reading start position) one pixel ahead.

In step S7, the reading section 61 reads pixel data from the VRAM 14, pixel by pixel in the raster scanning order, and causes the display unit 16 to output the pixels as a display.

In this manner, leftward scrolling by one column is implemented.

In step S8, the writing section 54 makes a determination as to whether the scrolling target column number n has reached the final column N (N being the rightmost end) of the image (whether n=N).

If the scrolling target column number n has not reached the image final column N, the result of the determination in step S8 is negative and the processing proceeds to step S9. In step S9, the writing section 54 increments the scrolling target column number n by 1 (n=n+1). Hence, the processing returns to step S4 and the subsequent processing is repeated. That is, leftward scrolling by another one column is implemented.

This processing in the loop from step S4 to step S9 is repeatedly executed, and when leftward scrolling by N columns has been implemented, the result of the determination in step S8 is affirmative and the processing proceeds to step S10.

In step S10, the writing section 54 makes a determination as to whether an amount by which the scanning start position has shifted is beyond a predetermined range.

Here, the number of pixels corresponding to the number of rows that are provided as free space in the storage region of the VRAM 14 (K×the number of pixels in one row) is employed as the predetermined range.

If the amount of shift of the scanning start position is not outside the predetermined range, the result of the determination in step S10 is negative, the processing returns to step S2, and the subsequent processing is repeated. In other words, the processing of the loops up to step S10 is repeatedly executed until the amount of shift of the scanning start position is beyond the predetermined range.

Then, in the processing of step S10 when the amount of shift of the scanning start position has gone beyond the predetermined range, the result of the determination is affirmative and the processing proceeds to step S11.

In step S11, the writing section 54 re-arranges the altered image data from the top of the VRAM 14 for subsequent scrolling processing.

Then, the scrolling processing ends. However, if scrolling is to continue in the same direction to display yet another image, the scrolling processing is immediately started again, and the sequence of processing described above is repeated from step S1.

The processing of step S3 and of the loop from step S4 to step S9 and the like that is executed in the case of a leftward scrolling instruction (when the result in step S2 is affirmative) has been described above. Now, the processing of step S12 and of a loop from step S13 to step S18 and the like that is executed in the case of a rightward scrolling instruction (when the result in step S2 is negative) is described.

As mentioned above, in the case of a rightward scrolling instruction, the result of the determination in step S2 is negative and the processing proceeds to step S12.

In step S12, the writing section 54 initializes the scrolling target column number n to the final column N (N being the rightmost end) of the image (n=N).

In step S13, the writing section 54 reads the data of column n of the altered image from the RAM 13.

In step S14, the writing section 54 writes this data of column n to column n of the VRAM 14, starting (offset by) one row upward.

In step S15, the reading position setting section 55 updates the correspondence information so as to shift the scanning start position (the reading start position) one pixel back.

In step S16, the reading section 61 reads the pixel data from the VRAM 14, pixel by pixel in the raster scanning order, and causes the display unit 16 to output the pixels as a display.

In this manner, rightward scrolling by one column is implemented.

In step S17, the writing section 54 makes a determination as to whether the scrolling target column number n has reached 1 (whether n=1).

If the scrolling target column number n has not reached 1, the result of the determination in step S17 is negative and the processing proceeds to step S18. In step S18, the writing section 54 decrements the scrolling target column number n by 1 (n=n−1). Hence, the processing returns to step S13 and the subsequent processing is repeated. That is, rightward scrolling by another one column is implemented.

This processing in the loop from step S13 to step S18 is repeatedly executed, and when rightward scrolling by N columns has been implemented, the result of the determination in step S17 is affirmative and the processing proceeds to step S10.

In step S10, the writing section 54 makes a determination as to whether an amount by which the scanning start position has shifted is beyond a predetermined range.

Here, as mentioned above, the number of pixels corresponding to the number of rows that are provided as free space in the storage region of the VRAM 14 (K×the number of pixels in one row) is employed as the predetermined range.

If the amount of shift of the scanning start position is not outside the predetermined range, the result of the determination in step S10 is negative, the processing returns to step S2, and the subsequent processing is repeated. In other words, the processing of the loops up to step S10 is repeatedly executed until the amount of shift of the scanning start position is beyond the predetermined range.

Then, in the processing of step S10 when the amount of shift of the scanning start position has gone beyond the predetermined range, the result of the determination is affirmative and the processing proceeds to step S11.

In step S11, the writing section 54 re-arranges the altered image data from the top of the VRAM 14 for subsequent scrolling processing.

Then, the scrolling processing ends. However, if scrolling is to continue in the same direction to display yet another image, the scrolling processing is immediately started again, and the sequence of processing described above is repeated from step S1.

The flow described above is concerned with scrolling processing when a displayed image is being replaced with another image. Therefore, scrolling in the opposite direction cannot be performed until the replacement with the other image is complete. However, it is possible for the scrolling direction to be changed during the image replacement. In this case, the processes from step S2 to step S10 may be repeatedly executed without the scrolling target column number being initialized in step S3 or step S12.

As described above, the image processing device according to the present embodiment is provided with the CPU 11, the VRAM 14 and the display control section 15.

The VRAM 14 functions as a display memory that is provided at least with free space corresponding to one row of the image to serve as a storage region for image data that is a target of display by the display unit 16.

The display control section 15 executes control that causes the display unit 16 to display an image represented by data stored in the VRAM 14, in accordance with correspondence information relating addresses in the VRAM 14 with positions on the display screen of the display unit 16.

More specifically, the display control section 15 displays an image at the display unit 16 by reading pixel data from the VRAM 14 in the raster scanning order in accordance with the correspondence information altered by the CPU 11, continuing from the address of a pixel that is scanned last in a row m (m being an integer value in the range from 1 to M, and M representing the number of rows in the image) to the address of the pixel that is scanned first in row m+1, and sequentially displaying the pixels at corresponding positions of the display unit 16.

The CPU 11 functions as a main control section that changes display positions of the image at the display unit 16, at least in the column arrangement direction, by altering the correspondence information.

Thus, the capacity of a buffer memory for scrolling (the VRAM 14) may be reduced without lowering a speed of scrolling. Moreover, scrolling may be implemented without the provision of complex address conversion circuitry, simply by altering the address of the reading start position (the scanning start position).

That is, an effect is provided in that satisfactory image scrolling can be implemented even under conditions of an underpowered CPU 11 and a small-capacity VRAM 14.

The VRAM 14 is provided with free space corresponding to K rows (K being an integer value that is at least 1) to serve as a storage region, and the CPU 11 updates all of the data in the VRAM 14 if scrolling continues in the same direction after scrolling by K×(the number of pixels in one row) columns in the column arrangement direction, or if scrolling continues in the same direction after scrolling by K rows in the row arrangement direction.

Thus, an effect is provided in that rapid scrolling in the column arrangement direction within a range corresponding to K×(the number of pixels in one row) columns is made possible simply by providing free space corresponding to K rows in the VRAM 14.

The image processing device is further provided with the RAM 13 that, in a case of scrolling from a first image (an original image) to a second image (an altered image) deploys the second image.

The CPU 11 reads the data of a column n of the second image from the RAM 13, writes this data to column n in the VRAM 14, starting from a position one row up or down, and alters the correspondence information such that the position at which reading of the data of a first pixel from the VRAM 14 starts, which is the reading start position (the scanning start position), is shifted by one pixel in the row direction.

Thus, an effect is provided in that scrolling one column at a time from the first image to the second image can be carried out quickly and smoothly.

The various effects described above are even more remarkable when the image processing device is employed at a digital camera. That is, a digital camera often displays the whole of a single captured image over the whole of a single display screen; for example, during preview display of an image that is being imaged. When an image is to be scrolled in this state, scrolling by an amount that exceeds the width of the screen is not required, and scrolling only in one direction, the left-right direction or the up-down direction, is sufficient. Therefore, the above effects are even more remarkable when the image processing device according to the present embodiment is employed at a digital camera.

It should be noted that the present invention is not limited to the embodiments described above, and any modifications and improvements thereto within a scope that can realize the object of the present invention are included in the present invention.

In the embodiment described above, scrolling is performed in the row direction (the left-right direction). However, the direction of scrolling is not particularly limited; scrolling in another direction such as the column direction (the up-down direction) or the like may also be implemented simply by executing processing with the same gist as the sequence of processing described above.

In the embodiment described above, an example in which the image processing device in which the present invention is employed is a digital camera is described, but this is not a particular limitation.

For example, the present invention may be generally applied to electronic devices with display control functions. Specifically, the present invention is applicable to, for example, notebook computers, printers, television sets, video cameras, portable navigation devices, portable telephones, smartphones, portable video game machines and so forth.

The processing sequence described above can be executed by hardware, and can also be executed by software.

That is, the functional structure in FIG. 2 is merely an example and is not particularly limiting. In other words, it is sufficient that a function capable of executing the whole of the above-described sequence of processing is provided at the image processing device; the kinds of functional blocks to be used for executing this function are not particularly limited by the example in FIG. 2.

A single functional block may be configured by a single piece of hardware, a single installation of software, or any combination thereof.

In a case in which the processing sequence is to be executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

As well as the removable medium 31 in FIG. 1 that is distributed separately from the main body of the equipment for supplying the program to users, a recording medium containing such a program may be constituted by a recording medium that is supplied to users in a state of being incorporated in the main body of the equipment. The removable medium 31 is constituted by, for example, a magnetic disc (such as a floppy disk), an optical disc, a magneto-optical disc or the like. The optical disk is composed of a CD-ROM (Compact Disc-Read Only Memory), a DVD (Digital Versatile Disc), or the like, for example. The magneto-optical disk is composed of an MD (Mini-Disk) or the like. A recording medium that is supplied to users in a state of being incorporated in the main body of the equipment is constituted by, for example, the ROM 12 of FIG. 4, in which the program is saved, a hard disc included in the storage section 21 of FIG. 1, or the like.

It should be noted that the steps in the present specification describing the program recorded in the storage medium include not only processing executed in a time series following this sequence, but also processing that is not necessarily executed in a time series but is executed in parallel or individually.

A number of embodiments of the present invention are explained hereabove. These embodiments are merely examples and do not limit the technical scope of the invention. The present invention may be attained by numerous other embodiments, and numerous modifications such as omissions, substitutions and the like are possible within a technical scope not departing from the spirit of the invention. These embodiments and modifications are to be encompassed by the scope and gist of the invention recited in the present specification, etc., and are encompassed by the inventions recited in the attached claims and their equivalents.

1. An image processing device comprising: a display memory that stores data of an image to be displayed at a display device, which is data of a plurality of pixels constituting the image in a plurality of rows and a plurality of columns;
a reading section that implements reading processing that reads the image data stored in the display memory and causes the image data to be displayed at the display device, the reading processing reading a plurality of the pixel data stored in the display memory in a storage address sequence, causing the sequentially read pixel data to be sequentially displayed while advancing a column position at the display device, and advancing a row position of the display at the display device each time reading of the pixel data corresponding to one row is complete; and
a reading position setting section that changes a position of the image displayed at the display device by altering positions of the reading of the plurality of pixel data by the reading section,
wherein
the reading section continuously reads all of the pixel data constituting the image in the address sequence, continuing from an address that stores the pixel data that is read last in a row to an address that stores the pixel data that is read first in the next row, and
the reading position setting section changes the position of the whole image displayed at the display device by altering an address at which the continuous reading of all the pixel data constituting the image starts.

2. The image processing device according to claim 1, wherein, as a storage region for data of the image to be displayed at the display device, the display memory provides both a storage region corresponding to the number of rows in the image and a free space region corresponding to at least one row, and
the reading position setting section is capable of changing the position of the whole image displayed at the display device at least in a column arrangement direction by altering, within a range of the number of pixels in one row, the address at which the continuous reading of all the pixel data constituting the image starts.

3. The image processing device according to claim 2, wherein the display memory provides free space corresponding to K rows as the storage region, and
the reading position setting section is capable of changing the position of the whole image displayed at the display device at least up to K rows in a row arrangement direction by altering, within a range of the number of pixels in K rows, the address at which the continuous reading of all the image data constituting the image starts.

4. The image processing device according to claim 2, further comprising a writing section that implements writing processing that acquires a plurality of pixel data constituting the image and writes this pixel data to addresses of the display memory, the writing processing continuing though addresses that store the plurality of pixel data of different columns in the same row, and continuing from a pixel data storage address at an end of a row to a pixel data storage address at the end of an adjacent row.

5. The image processing device according to claim 4 wherein, when the display position is changed in the column arrangement direction by the reading position setting section, the writing section acquires a new plurality of pixel data corresponding to a column at an opposite side from the direction of the alteration and stores this pixel data at addresses of the display memory.

6. The image processing device according to claim 5 wherein, if the display position is changed beyond a range in which alteration by the reading position setting section is possible and thereafter continues to be changed in the same direction, the writing section updates all the data in the display memory.

7. The image processing device according to claim 5, further comprising an operation detection section that detects a scrolling instruction to change the display position of the image,
wherein the reading position setting section alters the address at which the continuous reading of all the pixel data constituting the image starts in accordance with the scrolling instruction.

8. The image processing device according to claim 5, further comprising a memory that, in a case of scrolling from a first image to a second image, stores the second image,
wherein, each time scrolling by one column in the column arrangement direction is implemented, the writing section reads a plurality of pixel data stored in the memory, sequentially altering a reading target column position in the second image, and writes this pixel data to addresses corresponding to a column in the display memory at the opposite side of the display memory from the direction of scrolling,
and, each time scrolling by one column in the column arrangement direction is implemented, the reading position setting section shifts the address at which the continuous reading starts by one pixel in the column arrangement direction.

9. An image processing method executed by an image processing device equipped with a display memory that stores data of an image to be displayed at a display device, which is data of a plurality of pixels constituting the image in a plurality of rows and a plurality of columns, the image processing method comprising:
a reading step of implementing reading processing that reads the image data stored in the display memory and causes the image data to be displayed at the display device, the reading processing reading a plurality of the pixel data stored in the display memory in a storage address sequence, causing the sequentially read pixel data to be sequentially displayed while advancing a column position at the display device, and advancing a row position of the display at the display device each time reading of the pixel data corresponding to one row is complete; and
a reading position setting step of changing a position of the image displayed at the display device by altering positions of the reading of the plurality of pixel data by the reading step,
wherein
the reading step includes continuously reading all of the pixel data constituting the image in the address sequence, continuing from an address that stores the pixel data that is read last in a row to an address that stores the pixel data that is read first in the next row, and
the reading position setting step includes changing the position of the whole image displayed at the display device by altering an address at which the continuous reading of all the pixel data constituting the image starts.

10. A non-transitory computer readable storage medium having stored therein a program executable by a computer that controls an image processing device equipped with a display memory that stores data of an image to be displayed at a display device, which is data of a plurality of pixels constituting the image in a plurality of rows and a plurality of columns, causing the computer to realize:
a reading function that implements reading processing that reads the image data stored in the display memory and causes the image data to be displayed at the display device, the reading processing reading a plurality of the pixel data stored in the display memory in a storage address sequence, causing the sequentially read pixel data to be sequentially displayed while advancing a column position at the display device, and advancing a row position of the display at the display device each time reading of the pixel data corresponding to one row is complete; and
a reading position setting function that changes a position of the image displayed at the display device by altering positions of the reading of the plurality of pixel data by the reading function,
wherein
the reading function continuously reads all of the pixel data constituting the image in the address sequence, continuing from an address that stores the pixel data that is read last in a row to an address that stores the pixel data that is read first in the next row, and
the reading position setting function changes the position of the whole image displayed at the display device by altering an address at which the continuous reading of all the pixel data constituting the image starts.

11. An image processing device comprising: a display memory that serves as a storage region for data of an image that is a display target of a display device, the display memory providing at least free space corresponding to one row of the image;
a display control section that executes control causing an image represented by the data stored in the display memory to be displayed at the display device in accordance with correspondence information that relates an address in the display memory with a position of the display device; and
a main control section that changes a display position of the image at the display device at least in a column arrangement direction by altering the correspondence information,
wherein
the display control section causes the image to be displayed at the display device by sequentially reading pixel data in a raster scanning order in accordance with the correspondence information altered by the main control section, continuing from an address in the display memory of a pixel that is scanned last in a row m to the address of a pixel that is scanned first in a row m+1, and causing the pixels to be sequentially displayed at corresponding positions of the display device,
m represents an integer value in the range from 1 to M, and M represents the number of rows in the image.

12. The image processing device according to claim 11, wherein the display memory provides free space corresponding to K rows as the storage region,
if the main control section scrolls by an amount corresponding to the number of pixels in K rows in the column arrangement direction and is thereafter caused to continue scrolling in the same direction, the main control section updates all of the data in the display memory, and
K represents an integer value that is at least 1.

13. The image processing device according to claim 11, further comprising a memory that, in a case of scrolling from a first image to a second image, deploys the second image,
wherein the main control section
reads data of a column n of the second image from the memory and writes this data from a position one row ahead or back of a column n in the display memory, and
alters the correspondence information such that a position at which reading of the data of a first pixel from the display memory starts is shifted by one pixel in a row direction,
n represents an integer value in the range from 1 to N, and N represents the number of columns in the image.

14. An image processing method executed by an image processing device equipped with a display memory that serves as a storage region for data of an image that is a display target of a display device, the display memory providing at least free space corresponding to one row of the image, the image processing method comprising:
a display control step of executing control causing an image represented by the data stored in the display memory to be displayed at the display device in accordance with correspondence information that relates an address in the display memory with a position of the display device; and
a main control step of changing a display position of the image at the display device at least in a column arrangement direction by altering the correspondence information,
wherein
the display control step includes causing the image to be displayed at the display device by sequentially reading pixel data in a raster scanning order in accordance with the correspondence information altered by the processing of the main control step, continuing from an address in the display memory of a pixel that is scanned last in a row m to the address of a pixel that is scanned first in a row m+1, and causing the pixels to be sequentially displayed at corresponding positions of the display device,
m represents an integer value in the range from 1 to M, and M represents the number of rows in the image.

15. A non-transitory computer readable storage medium having stored therein a program executable by a computer that controls an image processing device equipped with a display memory that serves as a storage region for data of an image that is a display target of a display device, the display memory providing at least free space corresponding to one row of the image, causing the computer to realize functions of:
a display control unit that executes control causing an image represented by the data stored in the display memory to be displayed at the display device in accordance with correspondence information that relates an address in the display memory with a position of the display device; and
a main control unit that changes a display position of the image at the display device at least in a column arrangement direction by altering the correspondence information,
wherein
the computer that functions as the display control unit causes the image to be displayed at the display device by sequentially reading pixel data in a raster scanning order in accordance with the correspondence information altered by the main control unit, continuing from an address in the display memory of a pixel that is scanned last in a row m to the address of a pixel that is scanned first in a row m+1, and causing the pixels to be sequentially displayed at corresponding positions of the display device,
m represents an integer value in the range from 1 to M, and M represents the number of rows in the image.

16. The image processing device according to claim 12, further comprising a memory that, in a case of scrolling from a first image to a second image, deploys the second image,
wherein the main control section
reads data of a column n of the second image from the memory and writes this data from a position one row ahead or back of a column n in the display memory, and
alters the correspondence information such that a position at which reading of the data of a first pixel from the display memory starts is shifted by one pixel in a row direction,
n represents an integer value in the range from 1 to N, and N represents the number of columns in the image.
